(19) United States
(12) Patent Application Publication
(10) Pub. No.: US 2026/0142937 A1
(43) Pub. Date: May 21, 2026

(54) SYSTEMS, METHODS, AND DEVICES FOR CONFIGURABLE PACKET PIPELINE

(71) Applicant: Cypress Semiconductor Corporation, San Jose, CA (US)

(72) Inventor: Muhammad HAMEED, Parkland, FL (US)

(73) Assignee: Cypress Semiconductor Corporation, San Jose, CA (US)

(21) Appl. No.: 19/277,240

(22) Filed: Jul. 22, 2025

Related U.S. Application Data
(60) Provisional application No. 63/722,534, filed on Nov. 19, 2024.

(51) Int. Cl. H04L 49/00; H04L 49/90; H04W 52/02; H04W 80/04

(52) U.S. Cl. CPC H04L 49/3063; H04L 49/90; H04W 52/0209; H04W 80/04

(57) ABSTRACT

Systems, methods, and devices provide configurable pipelines for packets. Methods include identifying a plurality of segments associated with a packet having a format compatible with a wireless communications standard, and configuring a packet pipeline for at least one segment of the identified plurality of segments, the configuring including selecting and coupling at least some of a plurality of processing blocks to generate a packet pipeline having two or more stages, the configuring being based, at least in part, on the at least one segment. Methods further include performing, using the packet pipeline, one or more packet processing operations associated with the at least one segment of the packet based, at least in part, on the configuration of the at least some of a plurality of processing blocks.

### CROSS-REFERENCE TO RELATED APPLICATIONS

This application claims the benefit of U.S. Provisional Application No. 63/722534, filed on Nov. 19, 2024, which is incorporated by reference herein.

### TECHNICAL FIELD

This disclosure relates to wireless devices, and more specifically, to enhancement of packet processing in such wireless devices.

### BACKGROUND

Wireless devices may include transceivers configured to generate and receive wireless signals in accordance with one or more wireless communications protocols. For example, such wireless devices may establish wireless connections using a wireless communications protocol, such as a Bluetooth protocol. Data exchanged via such wireless connections may be included in packets structured in accordance with such wireless communications protocols. Conventional wireless devices remain limited because they are limited in their ability to efficiently support multiple different formats of such packets.

### BRIEF DESCRIPTION OF THE DRAWINGS

FIG. 1 illustrates an example of a device for packet pipelines, configured in accordance with some embodiments.

FIG. 2 illustrates an example of a method for configuring packet pipelines, performed in accordance with some embodiments.

FIG. 3 illustrates another example of a method for configuring packet pipelines, performed in accordance with some embodiments.

FIG. 4 illustrates an additional example of a method for configuring packet pipelines, performed in accordance with some embodiments.

FIG. 5 illustrates an example of a system for packet pipelines, configured in accordance with some embodiments.

FIG. 6 illustrates another example of a system for packet pipelines, configured in accordance with some embodiments.

FIG. 7 illustrates an additional example of a system for packet pipelines, configured in accordance with some embodiments.

### DETAILED DESCRIPTION

In the following description, numerous specific details are set forth in order to provide a thorough understanding of the presented concepts. The presented concepts may be practiced without some or all of these specific details. In other instances, well known process operations have not been described in detail so as not to unnecessarily obscure the described concepts. While some concepts will be described in conjunction with the specific examples, it will be understood that these examples are not intended to be limiting.

Wireless devices may communicate with each other via one or more wireless communications mediums. Such wireless communication may be implemented in accordance with one or more wireless communications protocols, such as a Bluetooth protocol. In various embodiments, such wireless communications protocols may have multiple different formats defined by multiple different standards. For example, a Bluetooth capable transceiver may support multiple different Bluetooth specifications such as Bluetooth Classic, Bluetooth basic rate/enhanced data rate (BR/EDR), and Bluetooth Low Energy (BLE). Each different specification may have its own packet format which may define which data fields are included in a packet, parameters of each data field, as well as an order of such data fields and corresponding data payloads.

Wireless devices may use implementations of custom hardware to perform processing operations associated with data field processing for packets. As will be discussed in greater detail below, such custom hardware may include custom processing logic that is configured to process data for such data fields as well as provide such data to other components that may be used for data reception or data transmission operations. Conventional techniques for processing data for such data fields remain limited because they use different sets of custom processing hardware for different packet standards. Accordingly, conventional techniques require the use of relatively large amounts of hardware resources to implement multiple sets of custom processing hardware, and are also limited in their ability to scale and support new standards and specifications that have new packet formats.

Embodiments disclosed herein provide configurable packet processing pipelines that enable dynamic configuration of processing blocks to implement an identified wireless communications standard. As will be discussed in greater detail below, such configurable packet processing pipelines may enable the dynamic configuration of a set of processing blocks for data fields of a wireless standard being used for a packet. The processing blocks included in the configurable pipeline may be reconfigured for different standards as well as to support new standards and may be dynamically configured for receive and/or transmit operations. In this way, overall hardware resource usage is reduced because multiple different sets of custom hardware are not needed for multiple different standards as well as new standards.

In various embodiments, dynamic configuration of packet pipelines disclosed herein reduces hardware resources used for packet processing because custom hardware is not needed for processing and/or generation of each data field, and instead, fundamental processing blocks may be rearranged and reused as packet pipelines are dynamically reconfigured during packet processing operations which may be used for transmission or reception operations. Moreover, such configurability of processing blocks also enables the support of custom formats for packets. More specifically, an entity, such as a user, manufacturer, or wireless standard, may create a new packet format that has a new arrangement of data fields. Instead of requiring new custom hardware to support that new arrangement of data fields specified by the new data format, configuration information and a mapping stored in a wireless device may be updated to support the new arrangements and configurations of processing blocks identified by the new packet format. As will be discussed in greater detail below, configuration logic may also be implemented via one or more processors to additionally reduce an amount of implemented logic dedicated to such packet processing operations.

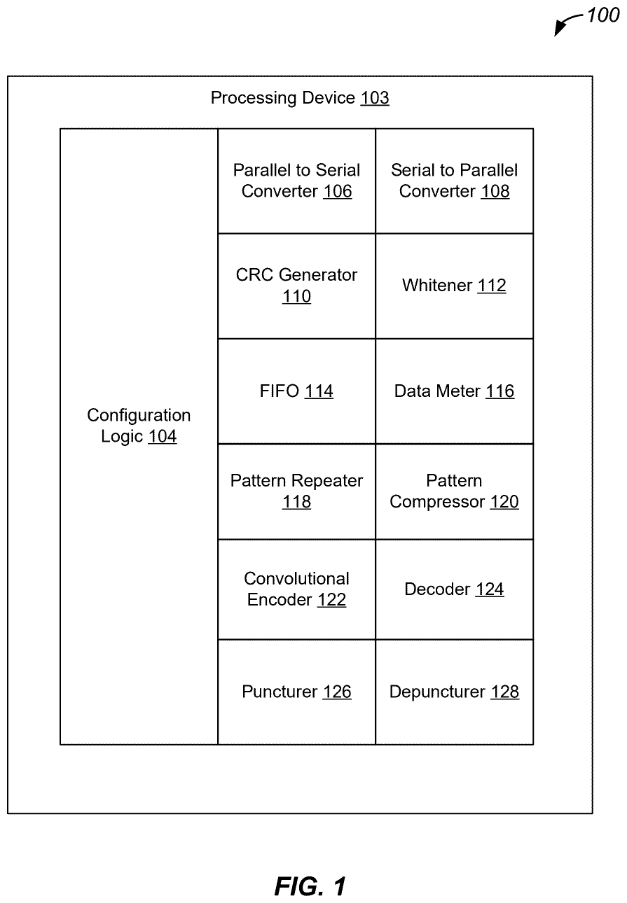

Furthermore, embodiments disclosed herein provide reduced hardware resource costs via the implementation of processors configured to implement custom instructions from memory. As will be discussed in greater detail below, such implementations of a processor may provide improved maintainability via firmware and firmware updates as opposed to redesign and reimplementation of hardware logic. Accordingly, a speed of implementing new protocols may be improved as well as writing and validating a ROM may be faster than designing and validating new hardware. Furthermore, common processing blocks (such as CRC, Whitening, Pattern mapping processing blocks among others) may be reused not only across multiple protocols (Bluetooth LE/LR/BR/EDR, 15.4, and Wi-Fi) but also across segments and fields within one packet. It will be appreciated that examples disclosed herein and in further detail below with reference to FIGS. 1-7 may make reference to data fields, but they may also contemplate and disclose segments of packets generally, and thus describe non-data fields such as tones, which may be sine waves, training sequences, or any other non-data field.

FIG. 1 illustrates an example of a device for packet pipelines, configured in accordance with some embodiments. As similarly discussed above, device 100 may include a processing device, such as processing device 103, that is configured to include multiple processing blocks that may be used to implement various processing operations used to process portions of packets in accordance with a wireless standard. As will be discussed in greater detail below, the processing blocks may be configured to have standardized data interfaces that may be used as either inputs or outputs. Accordingly, such processing blocks may be dynamically and configurably selected and/or arranged for a packet pipeline, and such standardized data interfaces may support data input or output operations regardless of where the processing blocks are positioned within the pipeline configuration or whether the processing block is being used for a transmit or receive operation.

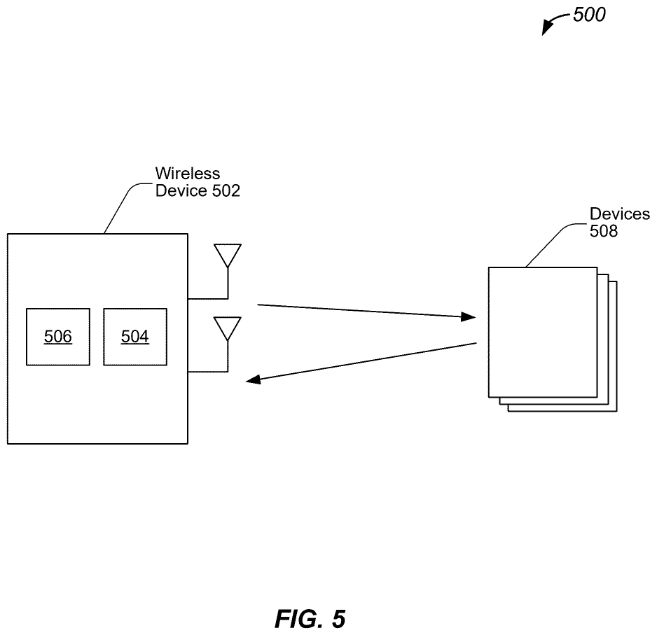

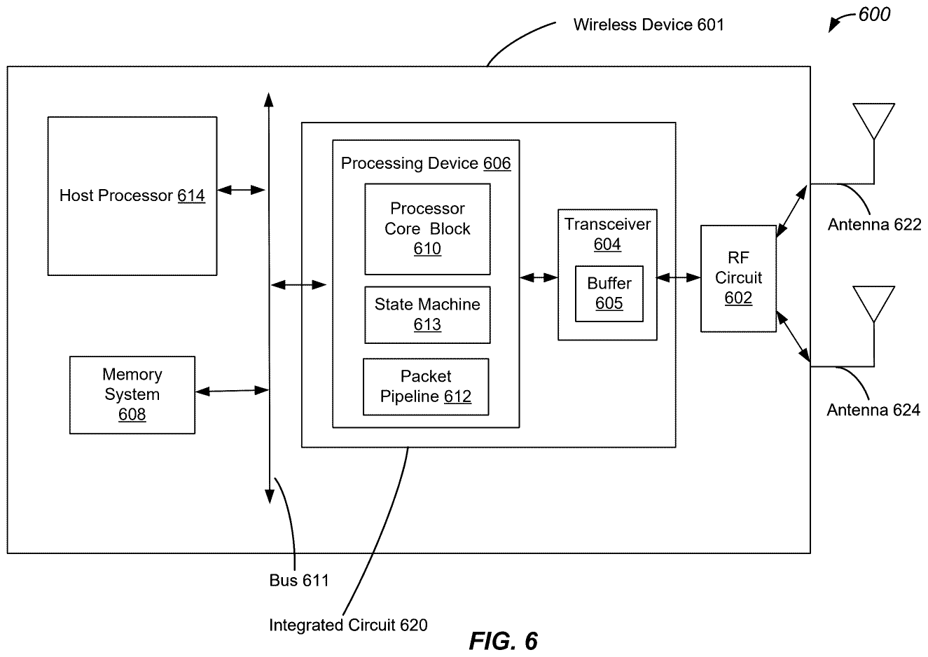

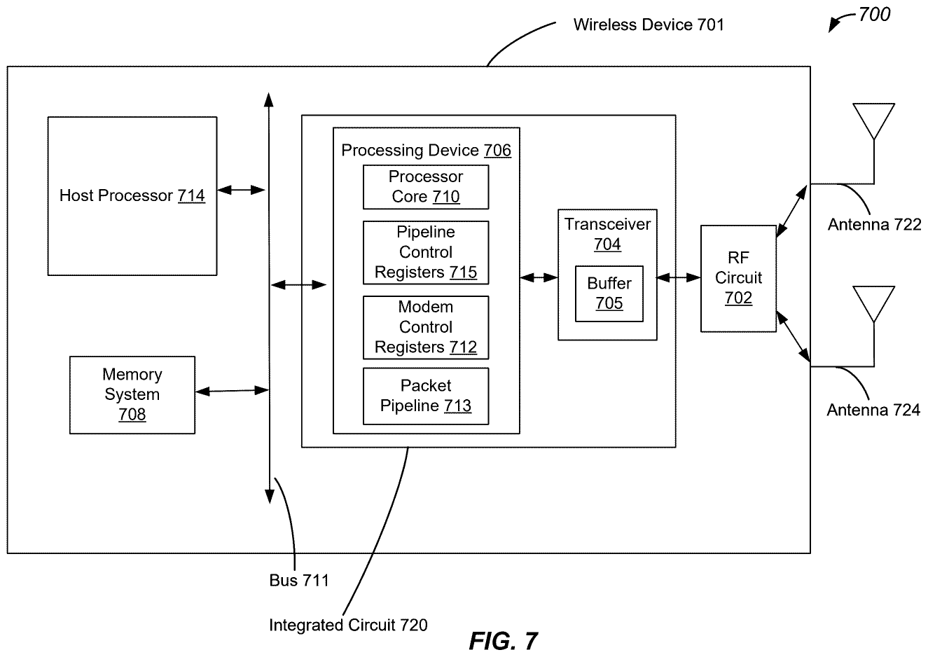

In various embodiments, processing device 103 is configured to include configuration logic 104 which is configured to determine and implement a configuration of a packet pipeline. For example, a wireless device may have data for transmission in a packet, or a packet may have been received during a receive operation and the wireless device may be extracting data from the received packet. Accordingly, a component of processing device 103, such as one or more processors, may be configured to determine a type of the packet as well as a format for such packet as may be determined based on a wireless standard, as similarly discussed in greater detail below with reference to FIGS. 5, 6, and 7. Based on the identified type and format of packet, a plurality of data fields may be identified that will collectively form the packet. Accordingly, all data fields that will be included in the packet may be identified. In various embodiments, a component, such as a state machine or processor core discussed in greater detail below with reference to FIG. 6 and FIG. 7, may be configured to step through data field operations for the identified data fields. In the example of data transmission, the data fields included in the packet may be identified, and data field generation operations may be stepped through for each data field to sequentially generate the packet for transmission.

In various embodiments, such state information may be provided to configuration logic 104 which is configured to use such state information to configure one or more processing blocks based on an identified current state. Accordingly, configuration logic 104 may be configured to generate and implement a configuration of a packet pipeline for each data field that will be included in the packet. As will be discussed in greater detail below, such pipelines may be configured and implemented dynamically based on the current state and data field identified by the state machine. Moreover, in some embodiments, such state information may be implemented via a processor core and pipeline control registers, as discussed in greater detail below with reference to FIG. 7. Accordingly, in some embodiments, configuration logic 104 may be implemented via pipeline control registers having values set by a separate processor core.

In various embodiments, configuration logic 104 is configured to generate such pipeline configurations based on a designated mapping of data fields to configurations of processing blocks. Accordingly, configuration logic 104 may receive an identified data field, and may identify one or more processing blocks as well as an order of such processing blocks based on a designated mapping stored and implemented within configuration logic 104. Such a designated mapping may be generated based on parameters specified by a wireless standard and may be configured and implemented by an entity, such as a manufacturer. Accordingly, a designated mapping of data fields to pipeline configurations may have been previously generated and stored in a storage location accessible to or included in processing device 103.

As shown in FIG. 1, multiple processing blocks may be implemented within processing device 103. In one example, such processing blocks are implemented in hardware. Accordingly, each processing block may be implemented via a configuration of hardware logic and gates. Moreover, each processing block may be configured to have standardized interfaces that are configured to be used as either inputs or outputs, and are also configured to enable data exchange regardless of where a processing block is implemented within a pipeline. It will be appreciated that the use of standardized interfaces additionally enables a processing block to be compatible with and usable with multiple different wireless protocols. For example, CRC Generator 110 may have standardized interfaces and be configured to be compatible with both BLE and Bluetooth Classic protocols. Accordingly, separate processing blocks are not needed for each wireless protocol as the standardized interface is configured to be compatible with all of the wireless protocols, and an overall gate count used to implement such processing blocks is reduced.

In various embodiments, a processing block may be implemented for each processing operation that may be used for a packet of a wireless standard. For example, processing device 103 may include processing blocks such as parallel to serial converter 106 and serial to parallel converter 108 that may handle serial/parallel data conversions. Additional processing blocks may include cycling redundancy check (CRC) generator 110 for CRC operations, whitener 112 for data whitening transformations, as well as data meter 116, pattern repeater 118, and pattern compressor 120. Additional processing blocks may include blocks for encoding and decoding, such as convolutional encoder 122 and decoder 124, as well as blocks for puncturing and depuncturing, such as puncture 126 and depuncturer 128. In various embodiments, processing device 103 additionally includes a first-in-first-out (FIFO) buffer, such as FIFO 114, which is configured to provide a buffer for a generated output that is sent to a downstream component, such as a transceiver. It will be appreciated that while FIG. 1 provides some examples of processing blocks, any suitable processing block for a processing operation for data field generation may be included within processing device 103.

In some embodiments, different combinations of processing blocks may be configured to implement different coding schemes for different wireless standards. For example, a BLE Long Range preamble generator may be implemented by disabling CRC Generator 110, Whitener 112, and enabling pattern repeater 118. In this way combinations of processing blocks may be used to generate standard-specific processing blocks, and such combinations may be implemented based on a designated mapping stored in memory, as will be discussed in greater detail below.

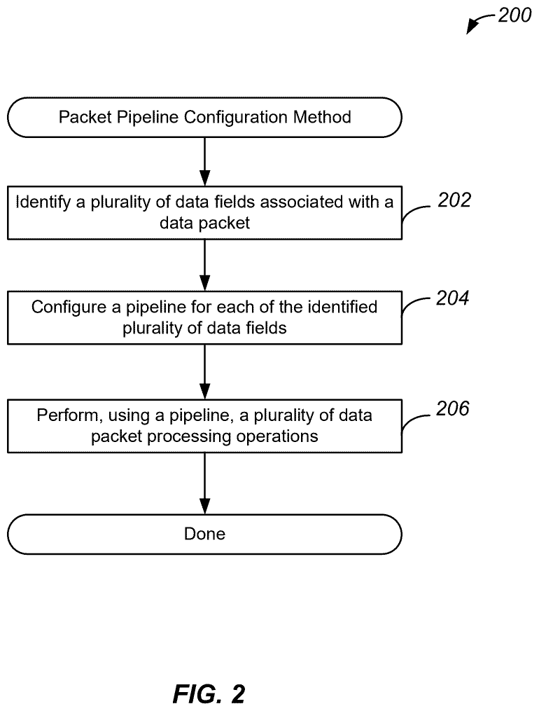

FIG. 2 illustrates an example of a method for configuring packet pipelines, performed in accordance with some embodiments. Accordingly, a method, such as method 200, may be performed to configure packet pipelines for packet processing. Accordingly, as will be discussed in greater detail below, method 200 may be performed to identify data fields based, at least in part, on one or more wireless standards used for data exchange, and to dynamically configure one or more packet pipelines for packet processing in accordance with the one or more wireless standards. As will be discussed in greater detail below, such configuration may include configuration logic or a processor configuring processing pipelines for each identified data field of a packet.

Method 200 may perform operation 202 during which a plurality of data fields associated with a packet may be identified. As similarly discussed above, a packet may be identified for transmission or may have been identified based on a receive operation, and may have a designated format determined based on a wireless standard. Accordingly, in the example of packet transmission, the plurality of data fields may be identified based on a determination of which data fields should be included to create the requested packet, and such a determination may be made based on specifications set forth by the wireless standard.

Method 200 may perform operation 204 during which a pipeline may be configured for each of the identified plurality of data fields. As similarly discussed above, one or more processing blocks may be coupled to each other to generate a processing pipeline for each of the identified data fields, and such coupling may be implemented via standardized interfaces of the processing blocks. As also discussed above, such a configuration or processing blocks may be implemented based on a designated mapping that identifies a configuration of processing blocks for each type of data fields. As will be discussed in greater detail below, a pipeline may be configured for a first data field, and pipelines may be configured for subsequent data fields when those subsequent data fields are generated. In this way, configuration and implementation of such pipelines may be performed sequentially in a process managed by a component, such as a hardware state machine or a processor.

Method 200 may perform operation 206 during which a plurality of packet processing operations may be performed using the pipeline. Accordingly, the processing blocks included in the configured pipeline may generate a data output based on one or more processing operations, and the data output may include data values to be included in the identified data field. In the example of a packet transmission, such a data output may be provided to a buffer for use by a transceiver for transmission. In this way, the contents of the data additional data fields for the remainder of the packet while transmission of the data output field may be provided to the transceiver for transmission, and additional pipelines may be configured for occurs.

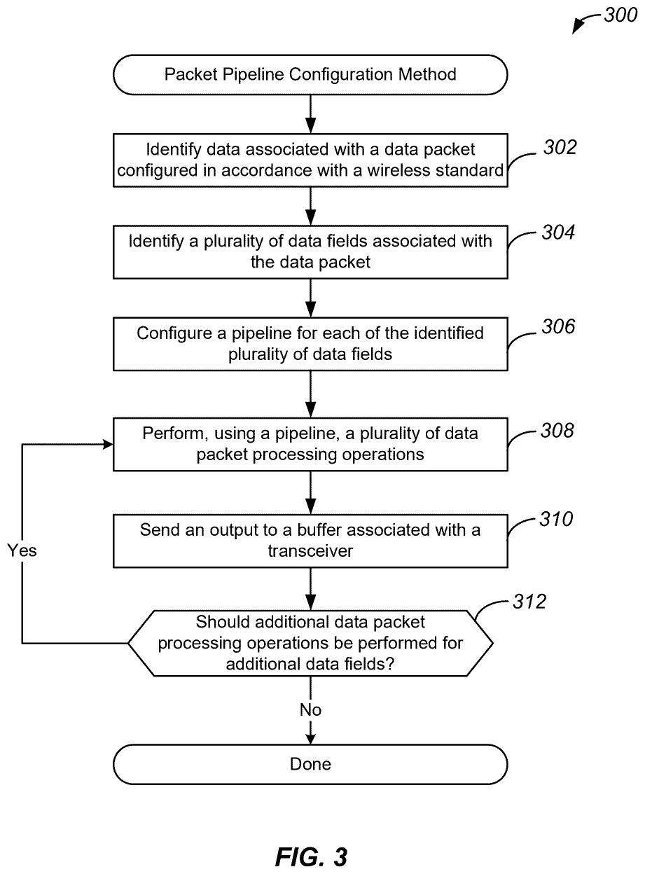

FIG. 3 illustrates another example of a method for configuring packet pipelines, performed in accordance with some embodiments. Accordingly, a method, such as method 300, may be performed to configure and implement multiple packet pipelines for different fields generated during packet generation and transmission. As will be discussed in greater detail below, method 300 may be performed to identify a sequence of data fields based, at least in part, on one or more wireless standards used for data exchange and properties of data to be transmitted. Moreover, method 300 may be performed to dynamically configure the packet pipelines the identified data fields in accordance with the one or more wireless standards. As will be discussed in greater detail below, such configuration may include configuration logic that is used to configure processing pipelines for each identified data field of the packet to be transmitted.

Method 300 may perform operation 302 during which data associated with a packet configured in accordance with a wireless standard may be identified. As similarly discussed above, a wireless device may determine that a data transmission operation should be performed, and data should be transmitted to another wireless device. Such a determination may be made based on data received from an application executed on the wireless device, or one or more other processing operations such as wireless connection activity. It will be appreciated that any data transmission event determined by the wireless device may be identified during operation 302, and data to be transmitted may also be determined.

Method 300 may perform operation 304 during which a plurality of data fields associated with the packet may be identified. As similarly discussed above, data for transmission may be identified, and a corresponding type of packet may be identified to transmit the data. Such a determination may be made based, at least in part, on a wireless standard which may specify a designated format of a packet to be used for a particular type of data to be transmitted and/or a particular type of data transmission. The designated format may define which data fields are included in the packet, and what type of data is included in each data field. Accordingly, during operation 304, the plurality of data fields may be identified based on a determination of which data fields should be included to create the requested packet, and such a determination may be made based on specifications set forth by the wireless standard.

Method 300 may perform operation 306 during which a pipeline may be configured for each of the identified plurality of data fields. In various embodiments, a hardware state machine may be configured to track a current state of packet generation. More specifically, the hardware state machine may be configured to identify a current data field being generated, and provide an indication of such current data field to another component, such as configuration logic. As similarly discussed above, the configuration logic may use the indication of current data field to identify one or more processing blocks that should be coupled in a packet pipeline for the identified data field. The configuration logic may establish connections between interfaces of the processing blocks via a bus or other connection circuitry. As also discussed above, the configuration of the processing blocks, which may identify which processing blocks are included in the pipeline and in what order, may be implemented based on a designated mapping that identifies a configuration of processing blocks for each type of data field. Accordingly, during operation 306, configuration logic may configure a packet pipeline based on a current data field identified by the configuration logic.

Method 300 may perform operation 308 during which a plurality of packet processing operations may be performed using the pipeline. Accordingly, the processing blocks included in the configured pipeline may generate a data output based on one or more processing operations, and the data output may include data values to be included in the identified data field. As similarly discussed above, the processing blocks may be configured to perform designated processing operations for data to be included in a packet. During operation 308, the processing blocks selected and configured during operation 306 may perform such processing operations as a pipeline where an output from one or more processing blocks is provided to an input of one or more other processing blocks of the pipeline via one or more standardized interfaces. It will be appreciated that some of the processing blocks may perform processing operations sequentially, and some of the processing blocks may perform processing operations independently or in parallel.

Method 300 may perform operation 310 during which an output may be sent to a buffer associated with a transceiver. As similarly discussed above, the buffer may be implemented with the processing blocks, or may be implemented in the transceiver. In various embodiments, the buffer is configured to receive the output of the pipeline generated during operation 308. As also discussed above, the output may include the contents of a data field that is to be transmitted by the transceiver. Accordingly, the buffer may store the contents of the data field until the transceiver reads such data and transmits it. Accordingly, while the transceiver is reading and transmitting the generated output, method 300 may perform additional pipeline configuration and processing operations to generate the contents of the next data field. In this way, the buffer stores data for a data field being transmitted while pipeline configuration operations and data output generation operations are performed for the next data field of the packet being transmitted. As will be discussed in greater detail below, this process may repeat until the end of the packet is reached.

Method 300 may perform operation 312 during which it may be determined if additional packet processing operations should be performed for additional data fields. In various embodiments, such a determination may be made based on the current state tracked by the hardware state machine. More specifically, the hardware state machine may determine whether or not there are any remaining data fields based on the position of the current data field relative to all the data fields initially identified for the requested packet. If there are still data fields remaining, the hardware state machine may increment the current data field to identify the next data field as the current data field, and method 300 may return to 308 where another pipeline may be configured for the next data field. If there are no remaining data fields, method 300 may terminate, or may repeat for an additional subsequent packet.

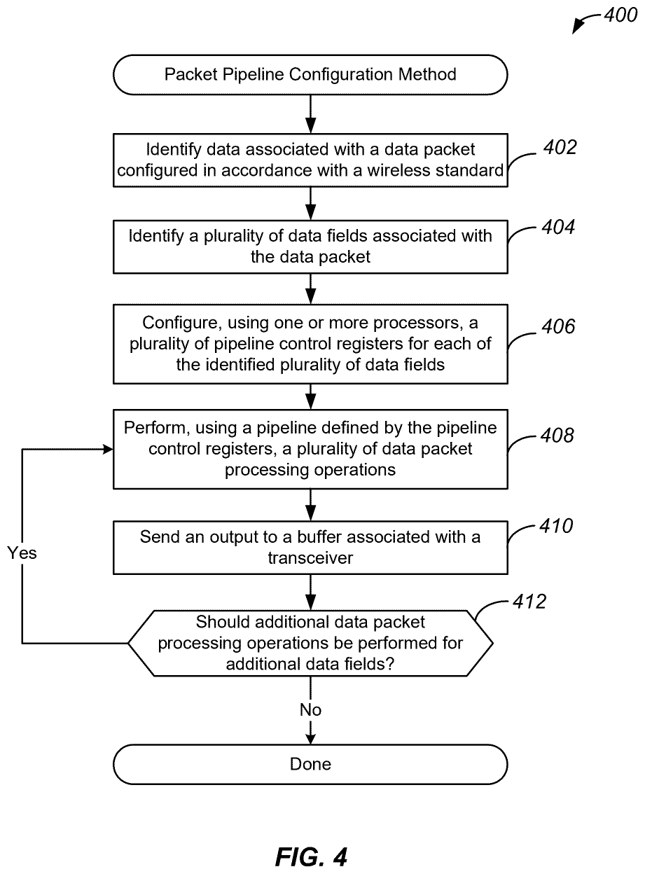

FIG. 4 illustrates an additional example of a method for configuring packet pipelines, performed in accordance with some embodiments. A method, such as method 400, may be performed to configure and implement multiple packet pipelines for different fields generated during packet generation and transmission. Accordingly, as will be discussed in greater detail below, method 400 may be performed to identify a sequence of data fields based, at least in part, on one or more wireless standards used for data exchange and properties of data to be transmitted. Moreover, method 400 may be performed to dynamically configure the packet pipelines the identified data fields in accordance with the one or more wireless standards. In various embodiments, the configuration of such processing blocks to dynamically assemble packet pipelines may be performed by a processor. Accordingly, a separate processor and associated control registers may be used for such packet pipeline configuration.

Method 400 may perform operation 402 during which data associated with a packet configured in accordance with a wireless standard may be identified. As similarly discussed above, a wireless device may determine that a data transmission operation should be performed, and data should be transmitted to another wireless device. Such a determination may be made based on data received from an application executed on the wireless device, or one or more other processing operations such as wireless connection activity. It will be appreciated that any data transmission event determined by the wireless device may be identified during operation 402, and data to be transmitted may also be determined.

Method 400 may perform operation 404 during which a plurality of data fields associated with a packet may be identified. As similarly discussed above, data for transmission may be identified, and a corresponding type of packet may be identified to transmit the data. Such a determination may be made based, at least in part, a wireless standard which may specify a designated format of data fields for a packet to be used for a particular type of data to be transmitted and/or a particular type of data transmission. Accordingly, during operation 404, the plurality of data fields may be identified based on a determination of which data fields should be included to create the requested packet, and such a determination may be made based on specifications set forth by the wireless standard.

Method 400 may perform operation 406 during which, using one or more processors, a plurality of pipeline control registers may be configured for each of the identified plurality of data. In various embodiments, a processor may be configured to track a current state of packet generation. As will be discussed in greater detail below, the processor may be a dedicated processor implemented separately from the processing blocks of the packet pipelines. For example, the processor may be implemented in a processor core block, or may be implemented as a separate lightweight processor or RISC processor. Accordingly, the processor may be communicatively configured to control the configuration of the processing blocks of the packet pipeline. In one example, the processor may implement such control via the setting of one or more values in control registers associated with the processing blocks. Moreover, such control registers may be configured to selectively enable or disable processing blocks to implement the pipeline configuration.

Accordingly, the processor may be configured to identify a current data field being generated, and may be further configured to use the indication of the current data field to identify one or more processing blocks that should be coupled in a packet pipeline for the identified data field. The processor may then set the values of the appropriate control registers to establish connections between interfaces of the identified processing blocks. As also discussed above, the configuration of the processing blocks, which may identify which processing blocks are included in the pipeline and in what order, may be implemented based on a designated mapping that identifies a configuration of processing blocks for each type of data field. Accordingly, during operation 406, the processor may configure a packet pipeline based on a current data field identified by the configuration logic.

Method 400 may perform operation 408 during which a plurality of packet processing operations may be performed using a pipeline defined by the pipeline control registers. As similarly discussed above, the processing blocks included in the configured pipeline may generate a data output based on one or more processing operations, and the data output may include data values to be included in the identified data field. Accordingly, during operation 408, the processing blocks selected and configured during operation 406 may perform such processing operations as a pipeline where an output from one or more processing blocks is provided to an input of one or more other processing blocks of the pipeline. It will be appreciated that some of the processing blocks may perform processing operations sequentially, and some of the processing blocks may perform processing operations independently or in parallel.

Method 400 may perform operation 410 during which an output may be sent to a buffer associated with a transceiver. As similarly discussed above, the buffer may be implemented with the processing blocks, or may be implemented in the transceiver. In various embodiments, the buffer is configured to receive the output of the pipeline generated during operation 408. As also discussed above, the output may include the contents of a data field that is to be transmitted by the transceiver. Accordingly, the buffer may store the contents of the data field until the transceiver reads such data and transmits it. Accordingly, while the transceiver is reading and transmitting the generated output, method 400 may perform additional pipeline configuration and processing operations to generate the contents of the next data field.

Method 400 may perform operation 412 during which it may be determined if additional packet processing operations should be performed for additional data fields. In various embodiments, such a determination may be made based on the current state tracked by the processor. More specifically, the processor may determine whether or not there are any remaining data fields based on the position of the current data field relative to all the data fields initially identified for the requested packet. If there are still data fields remaining, the processor may increment the current data field to identify the next data field as the current data field, and method 400 may return to 408 where another pipeline may be configured for the next data field. If there are no remaining data fields, method 400 may terminate, or may repeat for an additional subsequent packet.

FIG. 5 illustrates an example of a system for packet pipelines, configured in accordance with some embodiments. Accordingly, a system, such as system 500, may include wireless devices that are used for wireless communications, and are also configured to be able to perform pipeline configuration operations for packet processing as disclosed herein. Accordingly, as will be discussed in greater detail below, wireless devices included in system 500 may be configured to identify wireless standards used for data exchange, and dynamically configure a packet pipeline for data exchange in accordance with the identified wireless standard. Such configuration may include configuration logic or a processor configuring processing pipelines for each identified data field of a packet.

In various embodiments, system 500 may include wireless device 502 which may be a wireless communications device. As discussed above, such wireless devices may be compatible with one or more wireless protocols, such as a Bluetooth protocol. In some embodiments, wireless device 502 includes one or more transceivers. For example, wireless device 502 may include a Bluetooth transceiver, such as transceiver 504. Accordingly, transceiver 504 may be compatible with a Bluetooth specification and protocol. In some embodiments, transceiver 504 may be compatible with multiple standards of the Bluetooth protocol, such as Bluetooth Classic, Bluetooth BR/EDR, and BLE. It will be appreciated that wireless device 502 may be any suitable type of wireless device such as an Internet of Things (IoT) device, a smart device such as a smartphone or wearable device, or those found in cars and other vehicles, such as a head unit of an infotainment system.

As shown in FIG. 5, various wireless communications devices may be in communication with each other via one or more wireless communications mediums. Moreover, wireless device 502 may each include one or more antennas, and may also include processing device 506. As disclosed herein, a transceiver may also have associated transmit and receive chains and processing logic included in a corresponding radio. As similarly discussed above, such processing devices, transceivers, and radios may be configured to establish communications connections with other devices, and transmit data in accordance with packet formats defined by a wireless standard. Accordingly, wireless devices, such as wireless device 502, are configured to dynamically configure packet pipelines based, at least in part, on such packet formats, and use such dynamically configured packet pipelines to process data for data fields determined based on the packet formats.

In some embodiments, system 500 may further include devices 508 which may also be wireless devices. As similarly discussed above, devices 508 may be compatible with one or more wireless transmission protocols, such as a Bluetooth protocol. As similarly discussed above, devices 508 may be IoT devices, smart devices, or other devices, such as those found in gaming systems, cars, other vehicles, and medical implants. In various embodiments, devices 508 may be different types of devices than wireless device 502. As discussed above, each of devices 508 may include one or more antennas, as well as processing devices and transceivers, which may also be configured to establish communications connections with other devices, and transmit data in the form of packets via such communications connections. Accordingly, devices 508 may be configured to receive packets transmitted by wireless device 502.

FIG. 6 illustrates an example of a system for packet pipelines, configured in accordance with some embodiments. More specifically, FIG. 6 illustrates an example of a system, such as system 600, that includes wireless device 601. It will be appreciated that wireless device 601 may be one of the wireless devices discussed above with reference to FIG. 5, such as wireless device 502 and devices 508.

In various embodiments, wireless device 601 includes one or more transceivers, such as transceiver 604. In one example, system 600 includes transceiver 604 which is configured to transmit and receive signals using antenna 622 or antenna 624. As noted above, transceiver 604 may be a Bluetooth transceiver. Accordingly, transceiver 604 may be compatible with one or more Bluetooth standards such as Bluetooth Classic, Bluetooth BR/EDR, and BLE. In various embodiments, transceiver 604 includes a modulator and demodulator as well as one or more buffers and filters, that are configured to generate and receive signals via antenna 622 and/or antenna 624. While various embodiments are described with reference to Bluetooth communications protocols, it will be appreciated that any suitable protocol may be used.

In various embodiments, system 600 further includes processing device 606 which may include logic implemented using processing elements and/or one or more processor cores. In various embodiments, processing device 606 is configured to implement a wireless protocol interface. For example, a Bluetooth protocol may be implemented using a Bluetooth stack in which software is implemented as a stack of layers, and such layers are configured to compartmentalize specific functions utilized to implement the Bluetooth communications protocol. In various embodiments, a host stack includes layers for a Bluetooth network encapsulation protocol, radio frequency communication, service discovery protocol, as well as various other high level data layers. Moreover, a controller stack includes a link management protocol, a host controller interface, a link layer which may be a low energy link layer, as well as various other timing critical layers.

As will be discussed in greater detail below, processing device 606 includes processing elements that are configured to implement dynamic configuration of packet pipelines for packet processing performed in accordance with such a Bluetooth communications protocol. More specifically, processing device 606 includes one or more components configured to perform such dynamic configuration of packet pipelines, such as processor core block 610, state machine 613, and packet pipeline 612. As similarly discussed above with reference to FIG. 1, configuration logic included in packet pipeline 612 may be configured to configure processing blocks included in packet pipeline 612 to generate pipelines specific to identified data fields of a packet being processed, and utilization of such pipelines may be managed via state machine 613 and processor core block 610. Moreover, such configuration of the processing blocks may be implemented via configuration of a coupling between standardized interfaces of the processing blocks via an internal bus of packet pipeline 612. An output of packet pipeline 612 may be provided to a component of transceiver 604, such as buffer 605.

System 600 further includes radio frequency (RF) circuit 602 which is coupled to antenna 622 and antenna 624. In various embodiments, RF circuit 602 may include various components such as an RF switch, a diplexer, and a filter. While FIG. 6 illustrates system 600 as having two antennas, it will be appreciated that system 600 may have a single antenna, or any suitable number of antennas. Accordingly, RF circuit 602 may be configured to select an antenna for transmission/reception, and may be configured to provide coupling between the selected antenna, such as antenna 622, and other components of system 600 via a bus, such as bus 611. While one RF circuit is shown, it will be appreciated that wireless device 601 may include multiple RF circuits. Accordingly, each of multiple antennas may have its own RF circuit.

System 600 includes memory system 608 which is configured to store one or more data values associated with packet processing operations discussed above. Accordingly, memory system 608 includes a storage device, which may be a non-volatile random access memory (NVRAM) configured to store such data values, and may also include a cache that is configured to provide a local cache. In various embodiments, system 600 further includes host processor 614 which is configured to implement processing operations implemented by system 600.

It will be appreciated that one or more of the above-described components may be implemented on a single chip, or on different chips. For example, transceiver 604 and processing device 606 may be implemented on the same integrated circuit chip, such as integrated circuit 620. In another example, transceiver 604 and processing device 606 may each be implemented on their own chip, and thus may be disposed separately as a multi-chip module or on a common substrate such as a printed circuit board (PCB). It will also be appreciated that components of system 600 may be implemented in the context of a low energy device, and IoT device, a smart device, or a vehicle such as an automobile. Accordingly, some components, such as integrated circuit 620, may be implemented in a first location, while other components, such as antenna 622, may be implemented in second location, and coupling between the two may be implemented via a coupler such as RF circuit 602.

FIG. 7 illustrates an additional example of a system for packet pipelines, configured in accordance with some embodiments. More specifically, FIG. 7 illustrates an example of a system, such as system 700, that includes wireless device 701. It will be appreciated that wireless device 701 may be one of any of the wireless devices discussed above with reference to FIG. 5, such as wireless device 502 and devices 508.

In various embodiments, wireless device 701 includes one or more transceivers, such as transceiver 704 which is configured to transmit and receive signals using antenna 722 or antenna 724. As noted above, transceiver 704 may be a Bluetooth transceiver. Accordingly, transceiver 704 may be compatible with one or more Bluetooth standards such as Bluetooth Classic, Bluetooth BR/EDR, and BLE. In various embodiments, transceiver 704 may be coupled to processing device 706 which may include logic implemented using processing elements and/or one or more processor cores. In various embodiments, processing device 706 is configured to implement a wireless protocol interface. For example, a Bluetooth protocol may be implemented using a Bluetooth stack in which software is implemented as a stack of layers, and such layers are configured to compartmentalize specific functions utilized to implement the Bluetooth communications protocol, as similarly discussed above.

In various embodiments, processing device 706 includes processing elements that are configured to implement dynamic configuration of packet pipelines for packet processing performed in accordance with such a Bluetooth communications protocol. More specifically, processing device 706 includes one or more components configured to perform such dynamic configuration of packet pipelines, such as processor core 710, pipeline control registers 715, modem control registers 712, and packet pipeline 713. As similarly discussed above, processing blocks included in packet pipeline 713 may be configured to generate pipelines specific to identified data fields of a packet being processed. In various embodiments, utilization of such pipelines may be managed via processor core 710, pipeline control registers 715, and modem control registers 712. Accordingly, dynamic configuration of processing blocks within packet pipeline 713 may be controlled by processor core 710 via the configuration of data values stored in pipeline control registers 715 and modem control registers 712.

As similarly discussed above, processor core 710 may be “light” processor configured to have a relatively small CPU core that has less than or equal to an amount of hardware logic as a hardware state machine. Accordingly, implementation of processor core 710 may enable off-loading of logic from implemented hardware to memory, thus reducing an amount of hardware resource usage. Processor core 710 may be configured to execute custom instructions designed execute operations of a hardware state machine, and such custom instructions may be executed from memory. Custom instructions configured in this way provide processor core 710 with the ability to emulate the timing of a hardware state machine, thus providing accurate timing of packet processing operations.

In various embodiments, processing device 706 may also include an interface that provides communication between processor core 710 and other firmware implemented within processing device 706, such as firmware used to implement a Bluetooth stack. Accordingly, processor core 710 may be configured to receive commands from firmware via the interface, and may perform pipeline configuration operations based on such received commands. As similarly discussed above, such pipeline configuration operations may be performed at each segment of the packet. For example, a packet may have three segments such as a preamble, data payload, and tone. The preamble segment may have a first pipeline configuration, the data payload segment may have a second pipeline configuration, and the tone segment may have a third pipeline configuration. Processor core 710 may be configured to apply the different and corresponding pipeline configurations between packet segments. In this way, a packet having multiple segments may be constructed based on multiple pipeline configurations in sequence.

In some embodiments, processor core 710 is configured to selectively enable or disable processing blocks included in packet pipeline 713 via pipeline control registers 715 that may be configured to control settings for an internal bus of packet pipeline 713 that provides connectivity between standardized interfaces of such processing blocks. Moreover, modem control registers 712 may be configured to control coupling and operations of components of transceiver 704 used for transmission and/or reception operations.

In various embodiments, processor core 710 may also be configured to implement a custom sleep mode to reduce overall power consumption of processor core 710. More specifically, processor core 710 may be configured to enter a low-power idle state when not being used for packet pipeline configuration operations. Moreover, processor core may wake from such a custom sleep mode in response to a request for packet transmission being received or in response to a packet being received. In various embodiments, wake operations may be performed responsive to various other events as well. More specifically, a wake operation may be performed in response to a data field transition. For example, if a transition is occurring from a preamble to a data payload, or data payload to CRC, a wake operation may be performed. It will be appreciated that while some examples have been provided, such wake operations may be performed responsive to any field transition. Accordingly, wake and sleep operations may be performed dynamically and responsive to transitions between segments of transmit and receive operations disclosed herein. In various embodiments, such segments are generated in accordance with the operation of components discussed above, such as pipeline control registers 715. Once transitioned to an active mode, processor core 710 may perform packet pipeline configuration operations as discussed above.

In various embodiments, processor core 710 may be implemented using a lightweight processor or a reduced instruction set computer (RISC) processor. Accordingly, processor core 710 may be configured to track a current state of packet generation and identify a current data field for the current state. Moreover, processor core 710 may be configured to execute instructions stored in memory system 708 which may include a read-only memory (ROM) device, or may be a random-access memory (RAM) that may be shared with one or more other processors of system 700. In this way, configuration logic that was implemented via hardware may instead be implemented via software instructions stored in memory. For example, control logic designed and implemented via a hardware description language such as Verilog may instead be implemented via software and executed from memory. As similarly discussed above, an output of packet pipeline 713 may be provided to a component of transceiver 704, such as buffer 705. It will be appreciated that while FIG. 7 shows buffer 705, the buffer may be included in packet pipeline 713, as similarly discussed above with reference to FIG. 1.

System 700 further includes radio frequency (RF) circuit 702 which is coupled to antenna 722 and antenna 724. In various embodiments, RF circuit 702 may include various components such as an RF switch, a diplexer, and a filter. While FIG. 7 illustrates system 700 as having two antennas, it will be appreciated that system 700 may have a single antenna, or any suitable number of antennas. Accordingly, RF circuit 702 may be configured to select an antenna for transmission/reception, and may be configured to provide coupling between the selected antenna, such as antenna 722, and other components of system 700 via a bus, such as bus 711. While one RF circuit is shown, it will be appreciated that wireless device 701 may include multiple RF circuits.

System 700 includes memory system 708 which is configured to store one or more data values associated with packet processing operations discussed above. Accordingly, memory system 708 includes a storage device, which may be a non-volatile random access memory (NVRAM) configured to store such data values, and may also include a cache that is configured to provide a local cache. In various embodiments, system 700 further includes host processor 714 which is configured to implement processing operations implemented by system 700.

It will be appreciated that one or more of the above-described components may be implemented on a single chip, or on different chips. For example, transceiver 704 and processing device 706 may be implemented on the same integrated circuit chip, such as integrated circuit 720. In another example, transceiver 704 and processing device 706 may each be implemented on their own chip, and thus may be disposed separately as a multi-chip module or on a common substrate such as a printed circuit board (PCB). It will also be appreciated that components of system 700 may be implemented in the context of a low energy device, and IoT device, a smart device, or a vehicle such as an automobile. Accordingly, some components, such as integrated circuit 720, may be implemented in a first location, while other components, such as antenna 722, may be implemented in second location, and coupling between the two may be implemented via a coupler such as RF circuit 702.

Although the foregoing concepts have been described in some detail for purposes of clarity of understanding, it will be apparent that certain changes and modifications may be practiced within the scope of the appended claims. It should be noted that there are many alternative ways of implementing the processes, systems, and devices. Accordingly, the present examples are to be considered as illustrative and not restrictive.

What is claimed is:

1. A method comprising:
identifying a plurality of segments associated with a packet having a format compatible with a wireless communications standard;
configuring a packet pipeline for at least one segment of the identified plurality of segments, the configuring comprising selecting and coupling at least some of a plurality of processing blocks to generate a packet pipeline having two or more stages, the configuring being based, at least in part, on the at least one segment; and
performing, using the packet pipeline, one or more packet processing operations associated with the at least one segment of the packet based, at least in part, on the configuration of the at least some of a plurality of processing blocks.

2. The method of claim 1, wherein each of the plurality of processing blocks comprises a standardized input interface and a standardized output interface.

3. The method of claim 1, wherein data comprising the at least one segment of the packet is provided to a buffer coupled to a transceiver.

4. The method of claim 1, wherein the configuring of the packet pipeline is performed by a hardware state machine.

5. The method of claim 4 further comprising:
identifying, using the hardware state machine, a current segment being processed; and
determining a configuration of at least some of the plurality of processing blocks based, at least in part, on the identified current segment.

6. The method of claim 1, wherein the configuring of the packet pipeline is performed by a processor.

7. The method of claim 6 further comprising:
identifying, using the processor, a current segment being processed; and
determining a configuration of a plurality of control registers associated with at least some of the plurality of processing blocks based, at least in part, on the identified current segment.

8. The method of claim 7 further comprising:
setting the processor to a custom sleep mode; and
setting the processor to an active mode in response to determining that packet pipeline configuration operations should be performed.

9. The method of claim 1, wherein the wireless communications standard is a Bluetooth standard.

10. A system comprising:
a transceiver configured to transmit and receive wireless signals compatible with a wireless communications standard; and
a processing device comprising one or more processing elements configured to:
identify a plurality of segments associated with a packet having a format compatible with a wireless communications standard;
configure a packet pipeline for at least one segment of the identified plurality of segments, the configuring comprising selecting and coupling at least some of a plurality of processing blocks to generate a packet pipeline having two or more stages, the configuring being based, at least in part, on the at least one segment; and
perform, using the packet pipeline, one or more packet processing operations associated with the at least one segment of the packet based, at least in part, on the configuration of the at least some of a plurality of processing blocks.

11. The system of claim 10, wherein each of the plurality of processing blocks comprises a standardized input interface and a standardized output interface..

12. The system of claim 10, wherein data comprising the at least one segment of the packet is provided to a buffer coupled to a transceiver.

13. The system of claim 10, wherein the processing device further comprises a hardware state machine, and wherein the hardware state machine is configured to:
identify a current segment being processed; and
determine a configuration of at least some of the plurality of processing blocks based, at least in part, on the identified current segment.

14. The system of claim 10 wherein the processing device further comprises a processor, and wherein the processor is configured to:
identify a current segment being processed; and
determine a configuration of a plurality of control registers associated with at least some of the plurality of processing blocks based, at least in part, on the identified current segment.

15. The system of claim 14, wherein the processor is further configured to:
enter a custom sleep mode; and
enter an active mode in response to determining that packet pipeline configuration operations should be performed.

16. A device comprising:
one or more processing elements configured to:
identify a plurality of segments associated with a packet having a format compatible with a wireless communications standard;
configure a packet pipeline for at least one segment of the identified plurality of segments, the configuring comprising selecting and coupling at least some of a plurality of processing blocks to generate a packet pipeline having two or more stages, the configuring being based, at least in part, on the at least one segment; and
perform, using the packet pipeline, one or more packet processing operations associated with the at least one segment of the packet based, at least in part, on the configuration of the at least some of a plurality of processing blocks.

17. The device of claim 16, wherein each of the plurality of processing blocks comprises a standardized input interface and a standardized output interface. segment.

18. The device of claim 16, wherein the one or more processing elements comprise a hardware state machine, and wherein the hardware state machine is configured to:
identify a current segment being processed; and
determine a configuration of at least some of the plurality of processing blocks based, at least in part, on the identified current segment.

19. The device of claim 16, wherein the one or more processing elements comprise a processor, and wherein the processor is configured to:
identify a current segment being processed; and
determine a configuration of a plurality of control registers associated with at least some of the plurality of processing blocks based, at least in part, on the identified current segment.

20. The device of claim 19, wherein the processor is further configured to:
enter a custom sleep mode; and
enter an active mode in response to determining that packet pipeline configuration operations should be performed.
